(19) United States
(12) Patent Application Publication
(10) Pub. No.: US 2026/0103983 A1
(43) Pub. Date: Apr. 16, 2026

(54) DUST DETECTION AND MITIGATION ON WORKSITES

(71) Applicant: Caterpillar Inc., Peoria, IL (US)

(72) Inventors: Andrew J. Vitale, Edwards, IL (US); Craig L. Koehrsen, East Peoria, IL (US)

(73) Assignee: Caterpillar Inc., Peoria, IL (US)

(21) Appl. No.: 18/915,585

(22) Filed: Oct. 15, 2024

(51) Int. Cl. E21F 5/02; B05B 12/12; G01N 15/075

(52) U.S. Cl. CPC E21F 5/02; G01N 15/075; B05B 12/12

(57) ABSTRACT

A system of a plurality of machines operating on a worksite. The system includes a first machine, a second machine, and a controller. The second machine includes a dust detection system configured to detect fugitive dust. The controller is communicatively connected to each of the plurality of machines. On condition the second machine is adjacent the first machine on the worksite, the dust detection system identifies a dust zone of the first machine and senses fugitive dust levels in the dust zone. On condition the sensed fugitive dust levels are greater than or equal to a threshold dust level, the dust detection system communicates with the controller and the controller triggers a dust mitigation action.

### TECHNICAL FIELD

This disclosure relates generally to a system and method to monitor and manage fugitive dust on a worksite.

### BACKGROUND

Work environments associated with certain industries, such as the mining and construction industries, are susceptible to undesirable dust conditions. For example, worksites associated with mining, excavation, construction, landfills, and material stockpiles may be particularly susceptible to dust due to the nature of the materials composing the worksite surface. For example, worksite surfaces of coal, shale, stone, etc. erode easily, and thus may tend to produce significant amounts of dust. Moreover, typical work operations performed at these sites only exacerbate the dust conditions. At a mine site, for example, cutting, digging, and scraping operations may break up the worksite surface, generating dust. In addition, heavy machinery, such as haul trucks, dozers, loaders, excavators, etc., traveling on such sites may disturb settled dust, thereby increasing the dust level of the air.

Undue dust conditions may reduce the efficiency or otherwise degrade operations of a worksite. For example, dust may impair visibility, interfere with work operations on the site, and require increased equipment maintenance and cleaning. In addition, undue due dust conditions may compromise the comfort, health, and safety of worksite personnel.

U.S. Pat. No. 7,001,444, entitled “AUTOMATED DUST CONTROL METHOD” discloses an automated method for suppressing fugitive dust dissemination, which provides for automated measurement of dust levels at remote locations, transmission of the measurements to a centralized monitoring and control system which sends a signal to remote dust suppression treatment application apparatus which apply the appropriate dust suppression treatment chemicals.

### SUMMARY

In an example, a work machine includes a system of a plurality of machines operating on a worksite. The system includes a first machine, a second machine, and a controller. The second machine includes a dust detection system configured to detect fugitive dust. The controller is communicatively connected to each of the plurality of machines. On condition the second machine is adjacent the first machine on the worksite, the dust detection system identifies a dust zone of the first machine and senses fugitive dust levels in the dust zone. On condition the sensed fugitive dust levels are greater than or equal to a threshold dust level, the dust detection system communicates with the controller and the controller triggers a dust mitigation action.

In an example, a method includes operating a first machine and a second machine on a worksite, on condition the second machine is adjacent the first machine on the worksite, identifying a dust zone of the first machine and sensing fugitive dust levels in the dust zone, and on condition the sensed fugitive dust levels are greater than or equal to a threshold dust level, triggering a dust mitigation action.

These and other examples and features of the present devices, systems, and methods will be set forth in part in the following Detailed Description. This overview is intended to provide a summary of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically depicts an example worksite in accordance with this disclosure.

FIG. 2A schematically depicts an example worksite with a first machine traveling forward with a second machine behind the first machine also traveling forward on the worksite.

FIG. 2B schematically depicts an example worksite with a first machine traveling on a haul road while a second machine is adjacent to the side of the first machine.

FIG. 2C schematically depicts an example worksite with a first machine traveling forward with a second machine behind the first machine and stationary, traveling in reverse direction, or traveling forward in an opposite direction on a haul road.

FIG. 2D schematically depicts an example worksite with a first machine traveling forward on a haul road while a second machine is adjacent to the side of the first machine.

FIG. 3 is flow chart depicting an example method in accordance with this disclosure.

### DETAILED DESCRIPTION

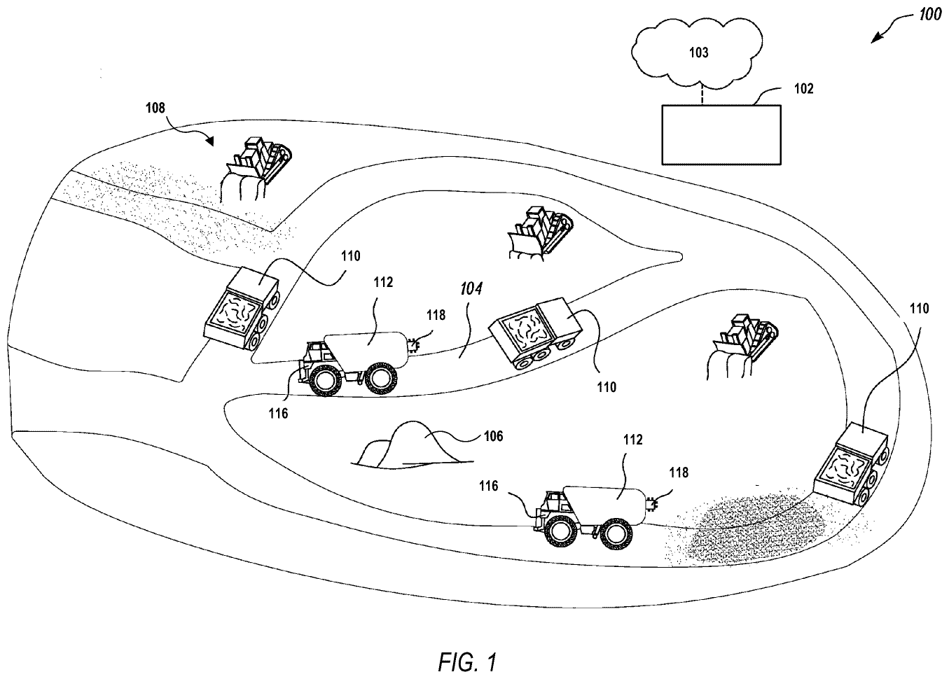

FIG. 1 illustrates an example worksite 100. The worksite 100 may be a surface mining site, a construction site, a landfill, or any other site where various operations and/or conditions generate dust. The presence of dust at the worksite 100 may reduce the efficiency or otherwise degrade operations. Worksite 100 includes controller(s) 102, network 103, haul roads 104, material deposit location(s) 106, work location(s) 108, material-transport machine(s) 110, fluid-delivery machine(s) 112, and dozer machine(s) 114.

Referring to FIG. 1, worksite 100 can include a variety of machines, including material-transport machines, fluid-delivery machines, and various other work machines. Worksite 100 can also include other machines, including light vehicles like trucks, SUVs, and ATVs/UTVs, as examples. A controller or multiple controllers 102 can be located somewhere on or remote from worksite 100 and communicatively connected to one or more of the machines operating on worksite 100 (and to one another, e.g., in situations including multiple controllers), e.g. via network 103. Worksite 100 can also include a network or multiple networks of haul roads 104 (or other vehicle/machine conveyance paths) by which machines on the worksite travel. And worksite 100 can include material deposit locations 106 and permanent/semi-permanent or temporary work locations 108.

The machines on worksite 100, including, e.g., material-transport machine 110 and fluid-delivery machine 112 may be operator-controlled, autonomous, or semi-autonomous machines. The machines can include mining machines, off-highway haul trucks, articulated trucks, excavators, loaders, dozers, scrapers, or other types of earth-working machines for performing various operations at the worksite 100. Material-transport machine(s) 110 are configured to transport excavated material to various locations on worksite 100, which may increase the dust level at the worksite.

Other machines, including, e.g., dozer machine 114 may include a work implement. The work implement may be any tool used in the performance of a work-related task. For example, work implement may include one or more of a blade, a shovel, a ripper, a dump bed, a fork arrangement, a broom, a grasping device, a cutting tool, a digging tool, a propelling tool, a bucket, a loader or any other tool known in the art. Various operations of dozer machine 114, including traveling on or off haul roads 104 and various uses of the work implement can also increase dust levels on worksite 100.

In connection with various work operations, the machines (e.g., 110, 112, and/or 114) may travel along haul roads 104 between excavation locations, dumping areas, and other locations on worksite 100. One or more of the haul roads 104 may be sloped, and one or more of the haul roads 104 may act as an entrance ramp into the worksite 100 and an exit ramp out of worksite 100. Fluid-delivery machine 112, e.g., may travel at the worksite 100 along haul roads 104 and to deliver fluid (e.g., spray fluid) onto the ground surface of worksite 100 to control dust levels.

Fluid-delivery machine 112 may be an off-highway truck converted for use to deliver fluid. The fluid-delivery machine 112 includes an engine (not shown), for example, an internal combustion engine or any other power source, which may be supported on a frame 116 of the fluid-delivery machine 112. The fluid-delivery machine 112 may be fitted with, among other things, a fluid tank configured to store fluid (e.g., water), various piping, hoses, pumps, valves, and one or more spray heads 118 that are configured to spray the fluid stored in the fluid tank onto the ground surface of worksite 100.

The amount of dust on worksite 100 can vary depending upon various factors, including environmental conditions (e.g., relative humidity, wind speeds, material composition of the worksite) and operations of the machines on the worksite (e.g., travel speed, machine load, machine accessory operation). In the event the amount of atmospheric dust, sometimes referred to as fugitive dust reaches a threshold level, it can be advantageous to take action to reduce dust levels and mitigate deleterious effects of the fugitive dust.

Examples according to this disclosure include a first machine and a second machine of a plurality of machines operating on a worksite. Any of the machines, depending, e.g., on environmental conditions and/or operating characteristics of the machines can generate undue (e.g. at or above a threshold level) dust on the worksite and any of the machines can be configured to detect fugitive dust levels. As the machines operate on the worksite, the first and second machines may be adjacent to one another. In an example of such a situation, the first machine may be traveling on the worksite and generating fugitive dust in a dust zone. The second machine, traveling or stationary adjacent to the first machine can include a dust detection system configured to identify a dust zone created by the first machine and sense fugitive dust levels in the dust zone. On condition the sensed fugitive dust levels are greater than a threshold dust level, the second machine can be configured to communicate with a controller configured to trigger a dust mitigation action.

In examples according to this disclosure, a pair of machines are described as being adjacent one another, e.g. a second machine adjacent a first machine. In the context of identifying and sensing dust levels in a dust zone, one machine being adjacent another machine does not require any fixed distance or proximity between the machines. A second machine including a dust detection system being adjacent a first machine can include, for example, the first machine being within a sensing range of the dust detection system of the second machine.

For worksite 100 of FIG. 1, as an example, material-transport machine 110 is traveling along one of haul roads 104. Fluid-delivery machine 112 is also traveling on the same branch of haul road 104 and is in relatively close proximity to material-transport machine 110. As it travels on road 104, material-transport machine 110 may generate increased levels of fugitive dust, e.g. in a zone behind the machine. Fluid-delivery machine 112 can include a dust detection system that can include, e.g., one or more perception sensors and is configured to detect fugitive dust in a dust zone.

A dust zone of a work machine on worksite 100 can be defined by a number of factors, including e.g., characteristics of the worksite and characteristics of machines on the worksite, based upon which dust detection systems in accordance with examples of this disclosure can identify the dust zone. For example, the dust detection system of fluid-delivery machine 112 and/or controller(s) 102 can have, e.g. store data indicative of characteristics of worksite 100 and characteristics of material-transport machine 110. In an example, the dust detection system of fluid-delivery machine 112 and controller(s) 102 are in communication including communicating the data indicative of worksite and machine characteristics and the dust detection system identifies dust zones, e.g. a dust zone created by material-transport machine 110 based one or both of worksite and machine characteristics.

In an example, the dust detection system of fluid-delivery machine 112 is configured to identify a dust zone of material-transport machine 110 and sense fugitive dust levels in the dust zone. On condition the sensed fugitive dust levels are greater than a threshold dust level, fluid-delivery machine 112 can be configured to communicate with controller(s) 102, which can trigger a dust mitigation action. For example, controller(s) 102 can command fluid-delivery machine 112 or signal fluid-delivery machine 112 to prompt an operator to spray fluid, e.g., water from spray heads 118 of the machine into the identified dust zone.

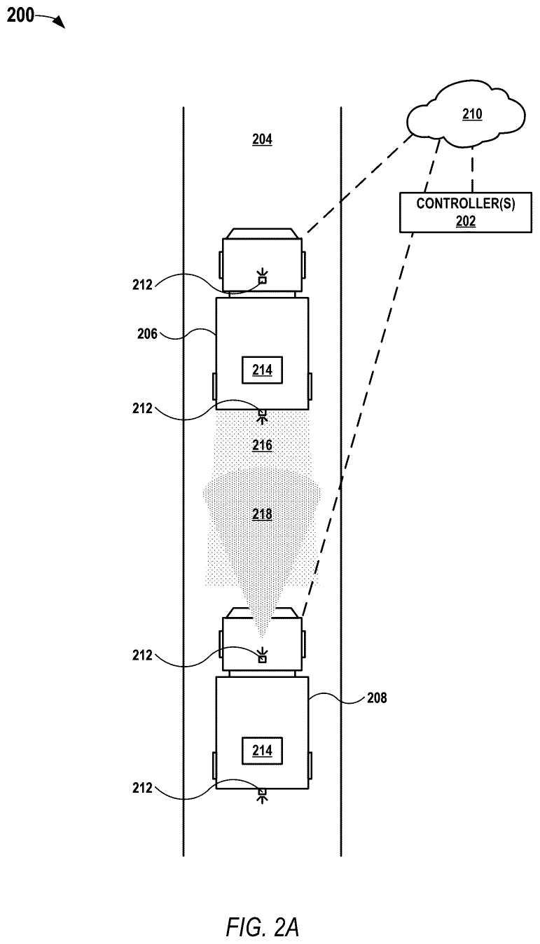

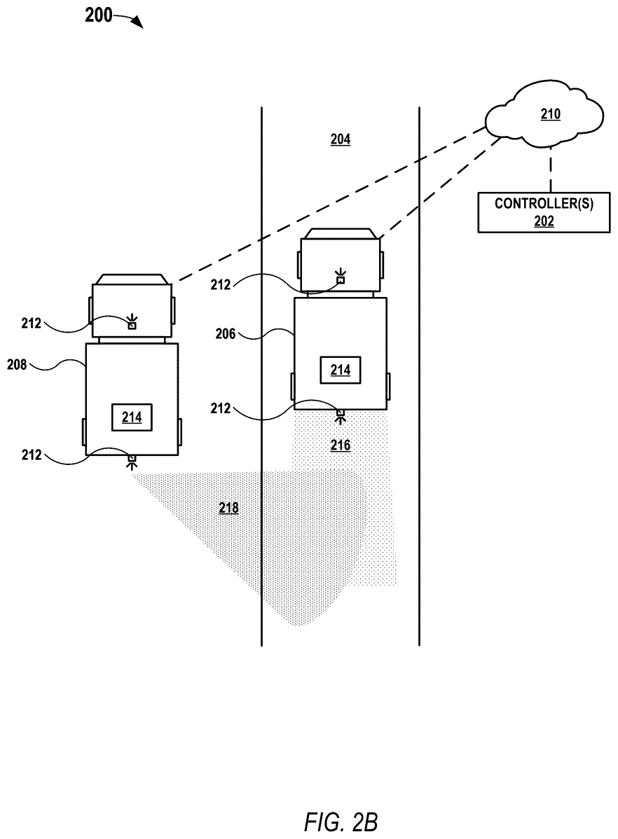

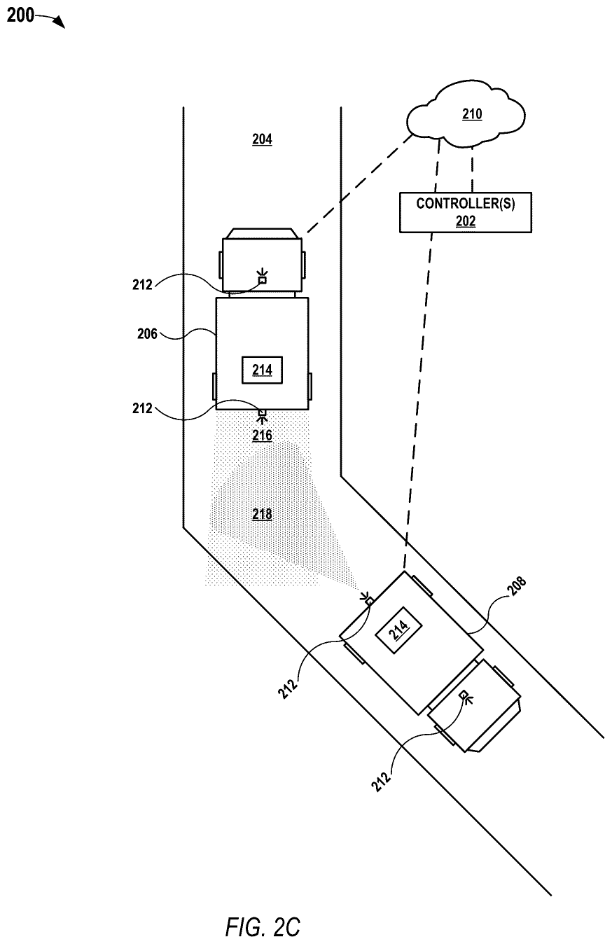

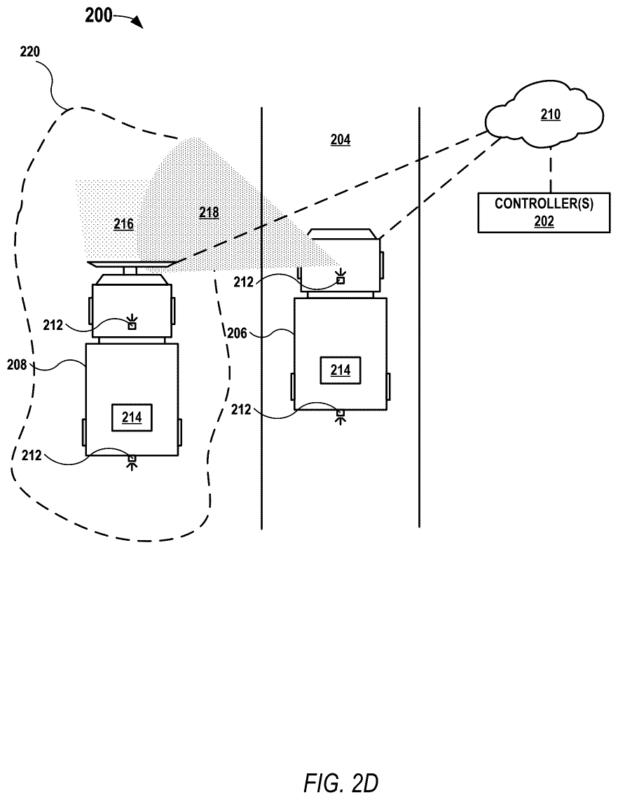

FIGS. 2A-2C schematically depict a portion of an example worksite 200. The worksite 200 may be a surface mining site, a construction site, a landfill, or any other site where various operations and/or conditions generate dust. The presence of dust at the worksite 200 may reduce the efficiency or otherwise degrade operations. Worksite 200 can include a variety of machines, including material-transport machines, fluid-delivery machines, and various other work machines. Worksite 200 can also include other machines, including light vehicles like trucks, SUVs, and ATVs/UTVs, as examples.

Referring to FIGS. 2A-2D, worksite 200 includes controller(s) 202, haul road 204, first machine 206, second machine 208, and network/cloud 210. Each of first machine 206 and second machine 208 can include perception sensor(s) 212 and electronic control unit (ECU) 214 (or other type of controller). The perception sensor(s) 212 and ECU 214 of each of first machine 206 and second machine 208 can form a dust detection system of the respective machine. Controller(s) 202 can be located somewhere on or remote from worksite 200 and communicatively connected to first machine 206 and second machine 208 via network 210, including being communicatively connected to perception sensor(s) 212 and ECU 214 of each machine via the network. The only difference between FIGS. 2A-2D are the relative adjacent positions of first machine 206 and second machine 208 and/or which of the machines is generating dust and which of the machines is detecting dust levels in a dust zone.

The machines on worksite 200, including, e.g., each of first machine 206 and second machine 208 can be operator-controlled, autonomous, or semi-autonomous machines. In an example, first machine 206 and second machine 208 are both autonomously operated machines. In an example, first machine 206 is operator-controlled and second machine 208 is autonomously operated. In an example, first machine 206 and second machine 208 are both operator-controlled machines. Other permutations of operator-controlled, autonomous, and semi-autonomous machines are also included in examples according to this disclosure.

In FIG. 2A, first machine 206 is traveling forward with second machine 208 behind first machine 206 also traveling forward on haul road 204. First machine 206 is generating dust in a dust zone 216. Perception sensor(s) 212 of second machine 208 are sensing dust levels (or other environmental properties indicative of dust levels) in at least a portion of dust zone 216 overlapping sensing zone 218.

In FIG. 2B, first machine 206 is traveling on haul road 204 while second machine 208 is to the side (the left side in the view of FIG. 2B) of first machine 206. First machine 206 is generating dust in a dust zone 216. Perception sensor(s) 212 of second machine 208 are sensing dust levels (or other environmental properties indicative of dust levels) in at least a portion of dust zone 216 overlapping sensing zone 218.

In FIG. 2C, first machine 206 is traveling forward with second machine 208 behind first machine 206 and stationary, traveling in reverse direction, or traveling forward in an opposite direction on haul road 204. First machine 206 is generating dust in a dust zone 216. Perception sensor(s) 212 of second machine 208 are sensing dust levels (or other environmental properties indicative of dust levels) in at least a portion of dust zone 216 overlapping sensing zone 218.

In FIG. 2D, first machine 206 is traveling forward on haul road 204 while second machine 208 is to the side (the left side in the view of FIG. 2D) of first machine 206. Second machine 208 is generating dust in a dust zone 216. Perception sensor(s) 212 of first machine 206 are sensing dust levels (or other environmental properties indicative of dust levels) in at least a portion of dust zone 216 overlapping sensing zone 218.

In FIGS. 2A-2D, controller(s) 202 can include one or more controllers, which are located at, near, or remote from worksite 200. Additionally, controller(s) 202 can include a plurality of controllers located at/distributed to different locations and communicatively connected to each other. Controller(s) 202 are communicatively connected to various devices, systems, etc. via network 210. For example, controller(s) 202 can be wirelessly connected to perception sensor(s) 212 and ECU 214 of each of first machine 206 and second machine 208 via network 210. In examples, controller(s) 202, whether one or more can work together and in conjunction with ECU 214 of each of first machine 206 and second machine 208. For example, perception sensor(s) 212 can be communicatively connected and configured to send signals to ECU 214 of each of first machine 206 and second machine 208 and each ECU 214 can be communicatively connected and configured to send signals and/or other pre and/or post-processed information to controller(s) 202, including information from perception sensor(s) 212. In another example, perception sensor(s) 212 can be communicatively connected and configured to send signals directly to controller(s) 202, which receive and process such sensor signals for various functions attributed generally to a controller or controllers in examples according to this disclosure.

Controller(s) 202 (and 102), ECUs 214 and other controllers in accordance with examples of this disclosure can be included in or separate from a machine. Examples according to this disclosure may include multiple controllers working in conjunction with each other to execute functions attributed to the controller(s). In examples, controller(s) can be part of or included in an electronic control unit ECU of the machine.

Controller(s), ECUs, etc. included in examples according to this disclosure can be configured to communicate with one another and with other components of the work machine via various wired or wireless communications technologies and components using various public and/or proprietary standards and/or protocols. Examples of transport mediums and protocols for electronic communication between components of the work machine include Ethernet, Transmission Control Protocol/Internet Protocol (TCP/IP), IEEE 802.11 or Bluetooth, or other standard or proprietary transport mediums and communication protocols.

In some examples, controller(s) can be included in an ECU of a machine. An electronic control unit (ECU) can be an embedded system that controls various aspects of machine operation. Types of ECUs include Electronic/Engine Control Module, Powertrain Control Module, Transmission Control Module, Brake Control Module, Suspension Control Module, among other examples. In the case of industrial, construction, and other heavy machinery, example ECUs can also include an Implement Control Module associated with one or more implements connected to and operable from the machine. These electronic modules/units can be communicatively connected and configured to send and receive data, sensor or other digital and/or analog signals, and other information between the various ECUs of machine 100. Additionally, functions attributed to an ECU or other controller, can be distributed among multiple devices.

Controller(s), whether onboard and/or separate from a machine, can include software, hardware, and combinations of hardware and software configured to execute a number of functions attributed to the components in the disclosed examples. Such controllers in examples according to this disclosure can be an analog, digital, or combination analog and digital controller including a number of components. As examples, the controller(s) can include integrated circuit boards or ICB(s), printed circuit boards PCB(s), processor(s), data storage devices, switches, relays, etcetera. Examples of processors can include any one or more of a microprocessor, a controller, a digital signal processor (DSP), an application specific integrated circuit (ASIC), a field-programmable gate array (FPGA), or equivalent discrete or integrated logic circuitry.

Controller(s), ECUs and other electronic controls in examples according to this disclosure can include storage media to store and/or retrieve data or other information, for example, signals from sensors. Examples of non-volatile storage devices include magnetic hard discs, optical discs, floppy discs, flash memories, or forms of electrically programmable memories (EPROM) or electrically erasable and programmable (EEPROM) memories. Examples of volatile storage devices include random access memories (RAM), dynamic random access memories (DRAM), static random access memories (SRAM), and other forms of volatile storage devices. The data storage devices can be used to store program instructions for execution by processor(s) of, for example, the controller(s).

Additionally, controller(s), ECUs and other electronic controls in examples according to this disclosure can include additional digital and/or analog components, including transmitters, receivers, transceivers, positioning systems, e.g., Global Positioning Systems, as examples. In an example, controller(s) and/or ECUs 214 can include GPS from which/by which the controller and/or ECU can send and receive data indicative of machine or other element position on worksite 200, as well as store and reference 2D or 3D maps of worksite 200.

Perception sensor(s) 212 of each of first machine 206 and second machine 208 may be a LIDAR (light detection and ranging) device, a RADAR (radio detection and ranging) device, a stereo camera, a monocular camera, or other perception sensing device. In examples, perception sensor(s) 212 may include an emitter that emits a detection beam or beams, which define a sensing zone 218. Further, perception sensor(s) 212 also include a receiver that may receive a reflection of the detection beam(s). The detection beam(s) may be reflected by a physical object. Perception sensor(s) 212 receive the beam(s) reflected by the physical object and determine the distance and the direction of the physical object from perception sensor(s) 212. By utilizing beams from plurality of directions, perception sensor(s) 212 may generate an image of worksite 200, e.g. in sensing zone 218. Perception sensor(s) 212 may also transmit the distance and direction of the physical object or other data/information indicative of sensor readings to controller(s) 202 and/or ECUs 214. In an embodiment, perception sensor(s) 212 may generate a 3D point map/cloud representation of worksite 200 describing the environment, e.g., in sensing zone 218. In examples, perception sensor(s) 212 may generate 2D images of worksite 200 or at least a portion of the worksite, e.g. in sensing zone 218.

Perception sensor(s) 212 of each of first machine 206 and second machine 208 can be connected to various locations on the respective machine to sense dust levels in dust zones. For example, each of first machine 206 and second machine 208 include a fore perception sensor 212 for sensing dust zones next to and/or forward of the machine, and an aft perception sensor 212 for sensing dust zones next to and/or rearward of the machine. In other examples according to this disclosure, a machine can include more or fewer than two perception sensors located at the same or different locations on the machine as perception sensor(s) 212.

Referring again to FIGS. 2A-2C, first machine 206 is traveling on haul road 204 with second machine 208 adjacent the first machine. First machine 206 is generating dust in a dust zone 216. Perception sensor(s) 212 of second machine 208 are sensing dust levels (or other environmental properties indicative of dust levels) in at least a portion of dust zone 216 overlapping sensing zone 218. Dust zone 216, sensing zone 218 and other dust and sensing zones described in examples according to this disclosure are depicted schematically and for illustrative purposes. The size and shape of these dust and sensing zones may vary depending on a variety of factors, e.g., environmental conditions and the type and characteristics of associated perception sensors.

In an example, second machine 208 is traveling on worksite 200 adjacent, in this case behind and in relatively close proximity to first machine 206. Perception sensor(s) 212 and ECU 214 of each of first machine 206 and second machine 208 can define a dust detection system of the machine. In this example, the dust detection system of second machine 208 can be configured to, automatically, semi-automatically, or in response to input from an operator of second machine 208, identify dust zone 216 of first machine 206. Controller(s) 202 may be monitoring and tracking machine activity and other parameters of worksite 200, including, e.g. environmental conditions. Controller(s) 202 can be, e.g., tracking the type, location, load, speed, and/or direction of the machines on worksite 200, including, e.g. first machine 206 and second machine 208.

Controller(s) 202 can also be monitoring and tracking characteristics of worksite 200. For example, controller(s) 202 can store 2-D and/or 3-D maps of worksite 200 and update such map with real time data indicative of machine travel pathway, e.g. haul road 204, locations and types of work zones on the worksite, as examples. Controller(s) 200 can also monitor and track data indicative of environmental conditions of worksite 200, including, e.g. temperature, humidity, wind speeds, as examples. The dust detection system of the machines on worksite 200, e.g. first machine 206 and second machine 208, and controller(s) can employ characteristics of the worksite and machines to identify dust zones.

In an example, the dust detection system of second machine 208 is configured to identify dust zone 216 of first machine 206 based on a location of the first machine, a speed of the first machine, and the location of haul road 204 on worksite 200. For example, ECU 214 of second machine 208 receives data from controller(s) 202 indicative of these characteristics of first machine 206, and based thereon, determines that a dust zone may be indicated behind first machine 206 on haul road 204. ECU 214 of second machine 208 can then control perception sensor(s) 212 to generate sensing zone 218 toward dust zone 216 of first machine 206. Perception sensor(s) 212 of second machine 208 can then sense dust levels (or other environmental properties indicative of dust levels) in at least a portion of dust zone 216 overlapping sensing zone 218. In an example, the dust detection system of second machine 208 is configured to identify dust zone 216 of first machine 206 based on data from controller(s) 202 indicative of characteristics of worksite 200 and characteristics of each of the plurality of machines on the worksite indicating first machine 206 is traveling on haul road 204. In an example, the dust detection system of second machine 208 is configured to identify dust zone 216 of first machine 206 based on data from controller(s) 202 indicative of characteristics of worksite 200 and characteristics of each of the plurality of machines on the worksite indicating a type of first machine 206 and that the first machine is traveling at or above a threshold speed on haul road 204.

In the event the level of dust in dust zone 216 detected by perception sensor(s) 212 of second machine 208 is greater than or equal to a threshold, ECU 214 communicates with controller(s) 202, which, in turn, can trigger a dust mitigation action, including communicating a location and dust level of the dust zone to one or more of a plurality of machines on worksite 200. In an example, controller(s) 202 communicate the location and dust level of dust zone 216 to a fluid delivery machine on worksite 200. In an example, worksite 200 includes a plurality of machines, including an autonomous fluid delivery machine. In such cases, controller(s) 202 can communicate the location and dust level of dust zone 216 to the autonomous fluid delivery machine, and, in response to receiving the location and dust level of the dust zone from the controller, the autonomous fluid delivery machine travels to the location of and delivers a dust suppressant fluid to the dust zone.

In the example of FIG. 2D, first machine 206 is traveling forward on haul road 204 while second machine 208 is to the side (the left side in the view of FIG. 2D) of first machine 206. In this example, second machine 208 is generating dust in a dust zone 216 while perception sensor(s) 212 of first machine 206 are sensing dust levels (or other environmental properties indicative of dust levels) in at least a portion of dust zone 216 overlapping sensing zone 218.

In an example, perception sensor(s) 212 and ECU 214 of each of first machine 206 and second machine 208 can define a dust detection system of the machine. In the example of FIG. 2D, the dust detection system of first machine 206 can be configured to, automatically, semi-automatically, or in response to input from an operator of first machine 206, identify dust zone 216 of second machine 208. Controller(s) 202 may be monitoring and tracking machine activity and other parameters of worksite 200, including, e.g. environmental conditions. Controller(s) 202 can be, e.g., tracking the type, location, load, speed, and/or direction of the machines on worksite 200, including, e.g. first machine 206 and second machine 208.

Controller(s) 202 can also be monitoring and tracking characteristics of worksite 200. For example, controller(s) 202 can store 2-D and/or 3-D maps of worksite 200 and update such map with real time data indicative of machine travel pathway, e.g. haul road 204, locations and types of work zones on the worksite, as examples. Controller(s) 200 can also monitor and track data indicative of environmental conditions of worksite 200, including, e.g. temperature, humidity, wind speeds, as examples. The dust detection system of the machines on worksite 200, e.g. first machine 206 and second machine 208, and controller(s) can employ characteristics of the worksite and machines to identify dust zones.

In an example, the dust detection system of first machine 206 is configured to identify dust zone 216 of second machine 208 based on a location of the second machine, a speed of the second machine, and the location of work zone 220 on worksite 200. For example, ECU 214 of first machine 206 receives data from controller(s) 202 indicative of these characteristics of second machine 208, and based thereon, determines that a dust zone may be indicated in front second machine 208. ECU 214 of first machine 206 can then control perception sensor(s) 212 to generate sensing zone 218 toward dust zone 216 of second machine 208. Perception sensor(s) 212 of first machine 206 can then sense dust levels (or other environmental properties indicative of dust levels) in at least a portion of dust zone 216 overlapping sensing zone 218. In an example, the dust detection system of first machine 206 is configured to identify dust zone 216 of second machine 208 based on data from controller(s) 202 indicative of characteristics of worksite 200 and characteristics of each of the plurality of machines on the worksite indicating second machine 208 is stationary or traveling at low speeds in work zone 220. In an example, the dust detection system of first machine 206 is configured to identify dust zone 216 of second machine 208 based on data from controller(s) 202 indicative of characteristics of worksite 200 and characteristics of each of the plurality of machines on the worksite indicating a type of second machine 208, e.g. a dozer and a load of the second machine, e.g. a load on a blade and/or bucket of second machine 208.

In the event the level of dust in dust zone 216 detected by perception sensor(s) 212 of first machine 206 is greater than or equal to a threshold, ECU 214 communicates with controller(s) 202, which, in turn, can trigger a dust mitigation action, including communicating a location and dust level of the dust zone to one or more of a plurality of machines on worksite 200. In an example, controller(s) 202 communicate the location and dust level of dust zone 216 to a fluid delivery machine on worksite 200. In an example, worksite 200 includes a plurality of machines, including an autonomous fluid delivery machine. In such cases, controller(s) 202 can communicate the location and dust level of dust zone 216 to the autonomous fluid delivery machine, and, in response to receiving the location and dust level of the dust zone from the controller, the autonomous fluid delivery machine travels to the location of and delivers a dust suppressant fluid to the dust zone.

In the examples of FIGS. 2A-2D, each of first machine 206 and second machine 208 include perception sensor(s) 212 and electronic control unit (ECU) 214. However, in examples according to this disclosure, a first machine generating dust may not include such components, e.g., not include perception sensors, while a second machine includes perception sensors and/or an ECU employed in a dust detection system that is configured to identify a dust zone adjacent the first machine and sense fugitive dust levels in the dust zone.

Additionally, although the dust zones 216 depicted in FIGS. 2A-2D are close to the machine that created them, in examples, the location of the dust zone and the location of the machine that created the dust zone can differ, e.g., when the dust generating machine has continued moving and therefore traveled on from a dust zone. Thus, in examples according to this disclosure, one machine including a dust detection system can identify and sense dust levels in a dust zone created by another machine without the two machines being adjacent one another.

### INDUSTRIAL APPLICABILITY

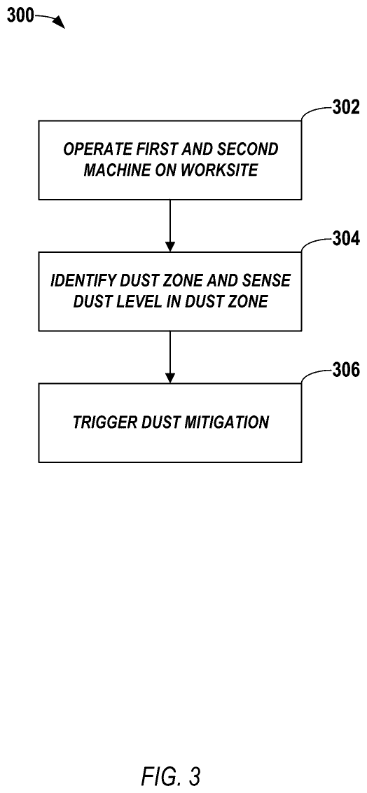

FIG. 3 is a flowchart depicting example method 300 in accordance with examples of this disclosure. Example method 300 includes operating a first machine and a second machine on a worksite (302), on condition the second machine is adjacent the first machine on the worksite, identifying a dust zone of the first machine and sensing fugitive dust levels in the dust zone (304), and on condition the sensed fugitive dust levels are greater than or equal to a threshold dust level, triggering a dust mitigation action (306).

In an example, a worksite includes a plurality of machines of various types and various states of operation. The machines can be distributed in different locations on the worksite and configured for different functions. Additionally, the worksite can have different environmental conditions, which affect work at the site in various ways, including affecting deleterious and/or disadvantages levels of dust, e.g. fugitive dust.

Any of the machines may, depending on different factors, including, e.g. characteristics of the machine (e.g., machine type, machine location on the worksite, machine load, machine speed, machine direction) and/or characteristics of the worksite (e.g. environmental conditions/characteristics like air temperature and humidity, wind speed, soil composition and humidity) may generate fugitive dust in a dust zone. Additionally, any of the machines on the worksite can be configured with or include a dust detection system that is configured to sense dust levels.

In an example, a controller or multiple controllers at or remote from the worksite are configured to operate in conjunction with machines on the worksite to detect deleterious and/or disadvantages levels of fugitive dust and to take one or more dust mitigation actions in response to such detection. For example, a first machine and a second machine are operating on the worksite (302). Each of the first machine and second machine include a dust detection system, which can include one or more perception sensor(s) and a machine controller like an ECU. Additionally, either or both of the first machine and the second machine can generate dust as they operate on the worksite.

At some point, the second machine is adjacent the first machine on the worksite. For example, the second machine is in front or behind the first machine on a haul road of the work site or the second machine is next to (e.g. to the right or left or other lateral side) the first machine. On condition the second machine is adjacent the first machine, the dust detection system of the second machine identifies a dust zone of the first machine and senses fugitive dust levels in the dust zone (304).

For example, the ECU of the dust detection system of the second machine is in communication with the controller(s) of the work site, which store or otherwise have data indicating various characteristics of the worksite, including, e.g., a two-dimensional or three-dimensional map of the worksite, machine travel pathways located on the worksite map, work zones located on the worksite map, or work zone types for the work zones. The ECU of the dust detection system of the second machine can identify the dust zone adjacent the first machine based on, e.g., worksite and machine characteristics indicating a type of the first machine and that the first machine is traveling at or above a threshold speed on a roadway on the worksite. In an example, the ECU of the dust detection system of the second machine can identify the dust zone adjacent the first machine based on, e.g., worksite and machine characteristics indicating the first machine is stationary or traveling at or below a threshold speed in a work zone. In an example, the ECU of the dust detection system of the second machine can identify the dust zone adjacent the first machine based on, e.g., worksite and machine characteristics indicating a type of the first machine and a load of the first machine. After identifying the possible dust zone adjacent the first work machine, one or more perception sensors of the second machine dust detection system can sense fugitive dust levels in the dust zone.

In the event the sensed fugitive dust levels are greater than or equal to a threshold dust level, a dust mitigation action can be triggered (306). For example, the controller(s) of the work site and/or an ECU of a machine, e.g. the second machine can communicate a location and the dust level of the dust zone to an autonomous, semi-autonomous, or operator controlled fluid-delivery machine and, in response to receiving the location and dust level of the dust zone from the controller, the fluid-delivery machine can travel to the location of the dust zone and deliver a dust suppressant fluid to the dust zone.

In the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific examples. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific examples. However, the benefits, advantages, solutions to problems, and any feature(s) that may cause any benefit, advantage, or solution to occur or become more pronounced are not to be construed as a critical, required, or essential feature of any or all the claims. Moreover, the particular examples disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular examples disclosed above may be altered or modified and all such variations are considered within the scope of the disclosed subject matter. Accordingly, the protection sought herein is as set forth in the claims below.

What is claimed is:

1. A system of a plurality of machines operating on a worksite, the system comprising:
a first machine of the plurality of machines;
a second machine of the plurality of machines, the second machine comprising a dust detection system configured to detect fugitive dust; and
a controller communicatively connected to each of the plurality of machines, wherein:
on condition the second machine is adjacent the first machine on the worksite, the dust detection system identifies a dust zone of the first machine and senses fugitive dust levels in the dust zone; and
on condition the sensed fugitive dust levels are greater than or equal to a threshold dust level, the dust detection system communicates with the controller and the controller triggers a dust mitigation action.

2. The system of claim 1, wherein each of the plurality of machines is an operator-controlled machine, autonomous machine, or semi-autonomous machine.

3. The system of claim 1, wherein the controller has data indicative of characteristics of the worksite and characteristics of each of the plurality of machines.

4. The system of claim 3, wherein the characteristics of the worksite comprise a two-dimensional or three-dimensional map of the worksite, machine travel pathways located on the worksite map, work zones located on the worksite map, or work zone types for the work zones.

5. The system of claim 4, wherein the machine travel pathways located on the worksite map comprise machine roadways located on the worksite map.

6. The system of claim 3, wherein the characteristics of each of the plurality of machines comprise machine type, machine location on the worksite, machine load, machine speed, or machine direction.

7. The system of claim 3, wherein the dust detection system identifies the dust zone based on the characteristics of the worksite and characteristics of the first machine.

8. The system of claim 7, wherein the dust detection system identifies the dust zone based on a location of the first machine, a speed of the first machine, and machine travel pathways located on a map of the worksite.

9. The system of claim 7, wherein the dust detection system identifies the dust zone based on the data indicative of characteristics of the worksite and characteristics of each of the plurality of machines indicating the first machine is traveling on a roadway on the worksite.

10. The system of claim 7, wherein the dust detection system identifies the dust zone based on the data indicative of characteristics of the worksite and characteristics of each of the plurality of machines indicating a type of the first machine and the first machine is traveling at or above a threshold speed on a roadway on the worksite.

11. The system of claim 7, wherein the dust detection system identifies the dust zone based on the data indicative of characteristics of the worksite and characteristics of each of the plurality of machines indicating the first machine is stationary or traveling at or below a threshold speed in a work zone.

12. The system of claim 7, wherein the dust detection system identifies the dust zone based on the data indicative of characteristics of the worksite and characteristics of each of the plurality of machines indicating a type of the first machine and a load of the first machine.

13. The system of claim 1, wherein:
the dust detection system comprises one or more perception sensors; and
the one or more perception sensors sense fugitive dust levels in the dust zone.

14. The system of claim 13, wherein:
the one or more perception sensors comprise a LIDAR sensor; and
the LIDAR sensor senses fugitive dust levels in the dust zone based on a three-dimensional point map including data indicating airborne particulate matter.

15. The system of claim 1, wherein the controller triggers the dust mitigation action comprises the controller communicates a location and dust level of the dust zone to one or more of the plurality of machines.

16. The system of claim 15, wherein the controller triggers the dust mitigation action comprises the controller communicates the location and dust level of the dust zone to a fluid delivery machine.

17. The system of claim 15, wherein:
the plurality of machines comprise an autonomous fluid-delivery machine;
the controller triggers the dust mitigation action comprises the controller communicates the location and dust level of the dust zone to the autonomous fluid-delivery machine; and
in response to receiving the location and dust level of the dust zone from the controller, the autonomous fluid-delivery machine travels to the location of and delivers a dust suppressant fluid to the dust zone.

18. A method comprising:
operating a first machine and a second machine on a worksite;
on condition the second machine is adjacent the first machine on the worksite, identifying a dust zone of the first machine and sensing fugitive dust levels in the dust zone; and
on condition the sensed fugitive dust levels are greater than or equal to a threshold dust level, triggering a dust mitigation action.

19. The method of claim 18, wherein identifying the dust zone comprises identifying the dust zone of the first machine based on one or both of characteristics of the worksite and characteristics of the first machine.

20. The method of claim 18, wherein triggering the dust mitigation action comprises communicating a location and the dust level of the dust zone to a fluid-delivery machine.

21. The method of claim 18, wherein triggering the dust mitigation action comprises:
communicating a location and the dust level of the dust zone to an autonomous fluid-delivery machine; and
in response to receiving the location and dust level of the dust zone from the controller, the autonomous fluid-delivery machine traveling to the location of the dust zone and delivering a dust suppressant fluid to the dust zone.

22. A system of a plurality of machines operating on a worksite, the system comprising:
a first machine of the plurality of machines;
a second machine of the plurality of machines, the second machine comprising a dust detection system configured to detect fugitive dust; and
a controller communicatively connected to each of the plurality of machines, wherein:
the dust detection system identifies a dust zone of the first machine and senses fugitive dust levels in the dust zone; and
on condition the sensed fugitive dust levels are greater than or equal to a threshold dust level, the dust detection system communicates with the controller and the controller triggers a dust mitigation action.
